(19) United States
(12) Patent Application Publication
(10) Pub. No.: US 2008/0168130 A1
(43) Pub. Date: Jul. 10, 2008

(54) METHOD AND SYSTEM FOR DETERMINING WHETHER TO SEND A SYNCHRONOUS OR ASYNCHRONOUS RESOURCE REQUEST

(76) Inventors: WEN-TZER THOMAS CHEN, Austin, TX (US); Men-Chow Chiang, Austin, TX (US); William A. Maron, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(21) Appl. No.: 11/621,193

(22) Filed: Jan. 9, 2007

(51) Int. Cl. G06F 15/16

(52) U.S. Cl. 709/203

(57) ABSTRACT

A system for making a determination to send a synchronous or asynchronous resource request. In response to sending a request to receive response time data for resource requests, the response time data for resource requests is received and stored. A request from a requester is received for response time data for a particular type of resource request. The response time data for the resource requests is searched for the particular type of resource request. In response to finding the response time data for the particular type of resource request within the response time data for the resource requests, the response time data for the particular type of resource request is sent to the requester. The requester either sends a synchronous or asynchronous resource request based on the response time data for the particular type of resource request.

### BACKGROUND

1. Field of the Invention

The present application relates generally to an improved data processing system. More specifically, the present invention is directed to a computer implemented method, system, and computer usable program code for making a determination to send a synchronous or asynchronous resource request based on response time data for a particular type of resource request.

2. Description of the Related Art

Today, when a multi-threaded application running on an application server issues a request to acquire a resource from a resource server via a network, the multi-threaded application is required to make a choice. The multi-threaded application may either let the thread issuing the request spin-wait, which holds the processor until the issuing thread receives a reply from the resource server, or cede the processor by means of a context-switch, which allows the multi-threaded application to schedule another thread to execute on the processor while the issuing thread waits for the reply from the resource server. While spin-waiting may result in better resource server response time, the multi-threaded application's throughput may suffer from wasting processor cycles in spin-wait. Even though context-switching utilizes processor cycles more efficiently, context-switching creates more processor overhead.

Static timing analysis may determine, even without resource request contention at the resource server, that spin-wait time is too long and that immediate context-switching upon sending a resource request is the best strategy. Response time is the time delay between the moment the application server sends the resource request and the moment the application server receives a response to the resource request. But, even if static timing analysis determines that the spin-wait time is less than the context-switching time, it may not always be favorable to use the spin-wait strategy. The reason for this is because the dynamic latency of the resource request may vary significantly due to queuing delay at the resource server. This queuing delay is created because the resource server is processing resource requests from multiple application servers.

One known solution is to always context-switch immediately after sending the resource request. Utilizing this known solution, places a fixed processor overhead on the application server in terms of path length (code required to execute the context-switch) or number of processor cycles used for each resource request. However, utilizing this solution does not allow for flexibility, especially if spin-wait provides better application server performance. Also, a secondary effect of utilizing this solution is that with more frequent context-switching, performance of context sensitive devices, such as hardware caches, may degrade.

A second known solution is to always spin-wait. When there is little resource request contention at the resource server, this known solution performs best. Especially, if the request response time for spin-waiting is significantly shorter than for context-switching. But, when resource request contention increases at the resource server, queuing delay increases too. This increased queuing delay may cause this solution to perform much worse than context-switching. In addition, there is no flexibility using this solution.

A third known solution is based on static timing for different types of resource requests. Static timing is the elapsed time for acquiring the resource when there is no resource request contention at the resource server. Consequently, static timing represents the best case scenario or the minimum response time for each type of resource request. The application server determines either to spin-wait or to context-switch based on the static timing of individual types of resource requests. However, when the resource server is servicing multiple application servers and these individual application servers experience significant fluctuation in load, the resource request rate to the resource server, the queuing delay, and response time for a resource request, can significantly vary. Therefore, an application server that employs a spin-wait strategy based on static timing may perform much worse than application servers employing a context-switch strategy, even though static timing analysis favors a spin-wait strategy.

A fourth known solution is to spin-wait for a fixed period of time and then context-switch for types of resource requests with short static timing. This known solution is similar to lock management used internally in a single server. This solution places an upper limit on processor overhead for individual resource requests. Therefore, when resource server load is low, context-switching by the application server is not necessary. But, when the static timing becomes longer, this solution pays a higher, though fixed, processor overhead than the first known solution above, which always context-switches without the initial spin-wait period.

Consequently, if the application server was able to determine the expected resource server response delay time, then the application server may be able to choose the best strategy to maximize throughput. Therefore, it would be beneficial to have an improved computer implemented method, system, and computer usable program code for determining whether to send a synchronous resource request or an asynchronous resource request from the application server based on response time data provided by the resource server for the particular type of resource request in order to increase application server performance.

### SUMMARY

Illustrative embodiments provide a computer implemented method, system, and computer usable program code for making a determination to send a synchronous or asynchronous resource request. In response to sending a request to receive response time data for resource requests, the response time data is received for the resource requests. The response time data for the resource requests is stored. A request from a requester is received for response time data for a particular type of resource request. The response time data for the resource requests is searched for the particular type of resource request. In response to determining that the response time data for the particular type of resource request is present within the response time data for the resource requests, the response time data for the particular type of resource request is sent to the requester. Then, based on the response time data for the particular type of resource request, the requester sends one of a synchronous resource request or an asynchronous resource request.

### BRIEF DESCRIPTION OF THE DRAWINGS

The novel features believed characteristic of the illustrative embodiments are set forth in the appended claims. The illustrative embodiments themselves, however, as well as a preferred mode of use, further objectives and advantages thereof, will best be understood by reference to the following detailed description of the illustrative embodiments when read in conjunction with the accompanying drawings, wherein:

FIG. 1 is a pictorial representation of a network of data processing systems in which illustrative embodiments may be implemented;

FIG. 2 is a block diagram of a data processing system is shown in which illustrative embodiments may be implemented;

FIG. 3 is a block diagram of an application server in accordance with an illustrative embodiment;

FIG. 4 is a flowchart illustrating an exemplary process for determining whether to send a synchronous or asynchronous resource request in accordance with an illustrative embodiment; and

FIGS. 5A and 5B are a flowchart illustrating an exemplary process for sending resource request response time data in accordance with an illustrative embodiment.

### DETAILED DESCRIPTION OF THE PREFERRED EMBODIMENT

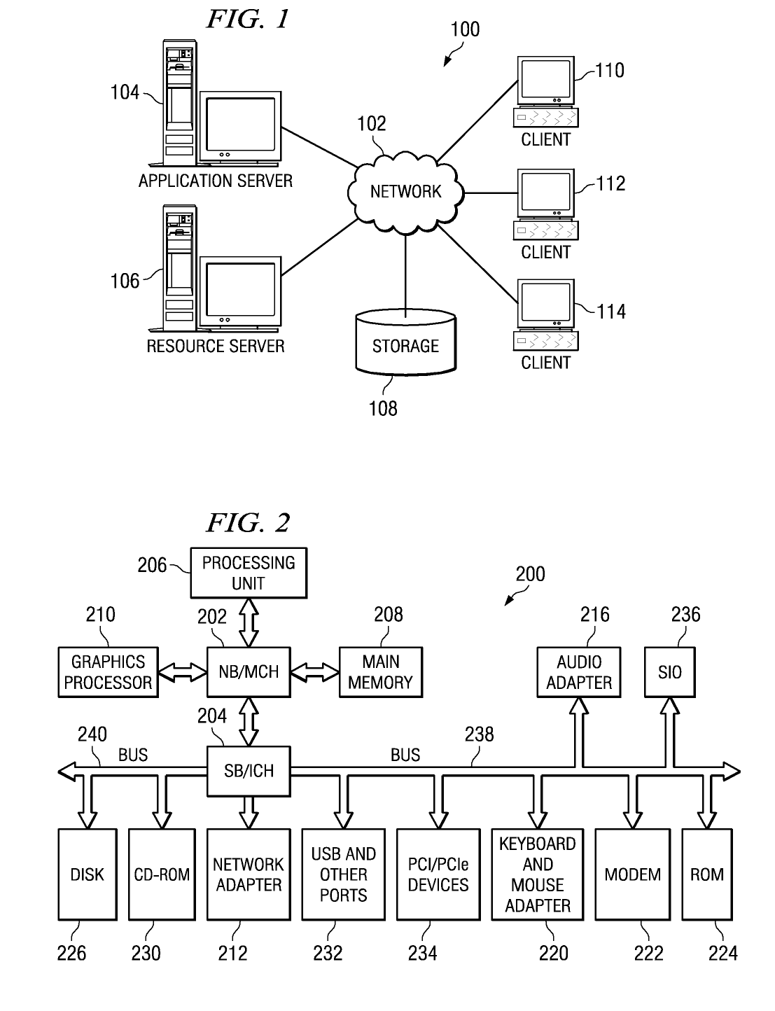

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between the various computers and other devices connected together within network data processing system 100. Network 102 may include connections, such as wire, wireless communication links, or fiber optic cables.

In the depicted example, application server 104 and resource server 106 connect to network 102, along with storage unit 108. Application server 104 is a server computer dedicated to running one or more software applications. In addition, application server 104 may represent a plurality of application servers coupled to network 102. Further, application server 104 may, for example, deliver these one or more software applications to client computers, such as clients 110, 112, and 114.

These one or more software applications may, for example, be multi-threaded applications. The term “thread” is short for thread of execution. Threads are a way for an application to split itself into two or more simultaneously executing tasks. Multi-threading generally occurs by time slicing, wherein a single processor switches between different threads. This process of the processor switching between different threads is known as context-switching. Software and/or hardware may perform this context-switching process.

Resource server 106 is a server computer dedicated to providing resources for resource requests. The resource requests come from a requester in application server 104. The requester may, for example, be an operating system (OS), an application, or a thread of a multi-threaded application executing in application server 104. However, it should be noted that resource server 106 is not limited to only providing resources for resource requests from requesters executing on application server 104. Resource server 106 may, for example, provide resources for resource requests from other data processing systems, such as clients 110, 112, and 114, in addition to, or instead of, application server 104.

Clients 110, 112, and 114 connect to network 102. In addition, clients 110, 112, and 114 may, for example, be personal computers or network computers. In this illustrative example, application server 104 provides data, such as boot files, operating system images, and applications to clients 110, 112, and 114. Further, clients 110, 112, and 114 are clients to application server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example and not as an architectural limitation for different embodiments.

With reference now to FIG. 2, a block diagram of a data processing system is shown in which illustrative embodiments may be implemented. Data processing system 200 is an example of a computer, such as application server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and MCH 202. Processing unit 206 may contain one or more processors and even may be implemented using one or more heterogeneous processor systems. Graphics processor 210 may be coupled to north bridge and MCH 202 through an accelerated graphics port (AGP), for example.

In the depicted example, LAN adapter 212 is coupled to south bridge and ICH 204 and audio adapter 216, keyboard and mouse adapter 220, modem 222, read only memory (ROM) 224, universal serial bus (USB) ports and other communications ports 232, and PCI/PCIe devices 234 are coupled to south bridge and ICH 204 through bus 238, and hard disk drive (HDD) 226 and CD-ROM drive 230 are coupled to south bridge and ICH 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and ICH 204.

An OS runs on processing unit 206 and coordinates and provides control of various components within data processing system 200 in FIG. 2. The OS may be a commercially available OS such as Microsoft® Windows® XP. Microsoft and Windows are trademarks of Microsoft Corporation in the United States, other countries, or both. An object oriented programming system, such as the Java™ programming system, may run in conjunction with the OS and provides calls to the OS from Java programs or applications executing on data processing system 200. Java and all Java-based trademarks are trademarks of Sun Microsystems, Inc. in the United States, other countries, or both.

Instructions for the OS, the object-oriented programming system, and applications or programs are located on storage devices, such as HDD 226, and may be loaded into main memory 208 for execution by processing unit 206. The processes of the illustrative embodiments may be performed by processing unit 206 using computer implemented instructions, which may be located in a memory such as, for example, main memory 208, ROM 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and MCH 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments provide a computer implemented method, system, and computer usable program code for determining whether to send a synchronous resource request or an asynchronous resource request from the application server based on response time data provided by the resource server for the particular type of resource request in order to increase application server performance. An application server utilizes a synchronous/asynchronous (SYN/ASYN) determination unit to send a request to receive response time data from a resource server via a network for different types of resource requests. In response to receiving the request for response time data for different types of resource requests, the resource server periodically sends the response time data to the requesting application server. Upon receipt of the response time data from the resource server, the SYN/ASYN determination unit stores the response time data for particular types of resource requests in a table within a storage device, such as a hard disk. The response time data table is an updatable table of currently expected resource request response times provided by the resource server on a periodic basis for particular types of resource requests.

A requester, which may be an OS, an application, or a thread of a multi-threaded application executing within the application server, requests response time data for a particular type of resource request from the SYN/ASYN determination unit. The SYN/ASYN determination unit searches the response time data table for the particular type of resource request. Subsequent to determining that the response time data for the particular type of resource request is present within the response time data table, the SYN/ASYN determination unit sends the response time data for the particular type of resource request to the requester. If the response time data for the particular type of resource request is not present within the response time data table, the SYN/ASYN determination unit may, for example, send a default response time for the particular type of resource request to the requester. In addition, the SYN/ASYN determination unit also may request the resource server to send response time data for that particular type of resource request to the SYN/ASYN determination unit now and periodically in the future. Afterward, a future requester of the same type of resource, along with the current requester if the current requester did not receive the default response time for the particular type of resource request earlier, either sends a synchronous resource request or an asynchronous resource request to the resource server based on the response time data for the particular type of resource request.

A synchronous resource request spin-waits for a response from the resource server. In other words, the requester, which issues the synchronous resource request, “holds” the processor or “blocks” other requesters from executing on the processor, until the response is received from the resource server. In contrast, the asynchronous resource request context-switches immediately after issuing the resource request. In other words, the requester, which issues the asynchronous resource request, “cedes” or surrenders the processor immediately after issuing the resource request in order that other requesters may execute on the processor while the issuing thread waits for the response from the resource server.

Thus, illustrative embodiments project the response time of resource requests based on data periodically broadcast from the resource server. The decision to spin-wait or context-switch for a particular resource request type is based on current load, or very recent load, of the resource server. The resource server calculates expected response time for different types of resource requests based on the resource server's knowledge of the queue lengths for different types of resource requests and the resource server's servicing priority policy for these different types of resource requests.

The servicing priority policy is a procedure for prioritizing resource requests in one or more queues. For example, the servicing priority policy may include procedures, such as increase the priority of spin-wait resource requests, decrease the priority of context-switch resource requests, and increase the priority of long-waiting resource requests. A long-waiting resource request is a resource request that remains in a queue longer than a pre-determined amount of time.

The response time calculations performed by the resource server are available to the application server upon request. As a result, the application server may effectively adapt to dynamic workload changes on the resource server. Broadcast of current resource request response time data to the application servers by the resource server need not be a serious overhead on processing or communication resources.

Illustrative embodiments may, for example, regulate the frequency of the broadcasts such that the broadcast only requires less than 1% of the processing capacity or communication bandwidth. Furthermore, the broadcast may be on an irregular time period interval. For example, the resource server may optimize the frequency of broadcasts by only broadcasting the resource request response time data when a significant change in response time occurs that will cause the application server to switch the request/wait decision from sending synchronous resource requests to asynchronous resource requests or vice versa. Broadcasting only when the resource request response time data is necessary to make a difference in the application server's throughput may drastically reduce the demand on resource server communication bandwidth and application server processing capacity.

Further, it should be noted that the change in expected response time calculated by the resource server may not be completely due to a change in resource server workload. The change in expected response time calculations also may be due to resource server adaptability to changes in the resource server's servicing priority policy of resource requests to accommodate the changing composition of the resource server's workload. Moreover, the change in expected response time calculations may be due to changes in the processing capacity of the resource server.

Context-switch time may, for example, be provided by the OS, since the OS controls the context-switch process. The OS may periodically measure this context-switch time and then calculate an average context-switch time with aging to give more weight to more recently measured context-switch times. This average context-switch time may be made available to the requester as, for example, a library or system call.

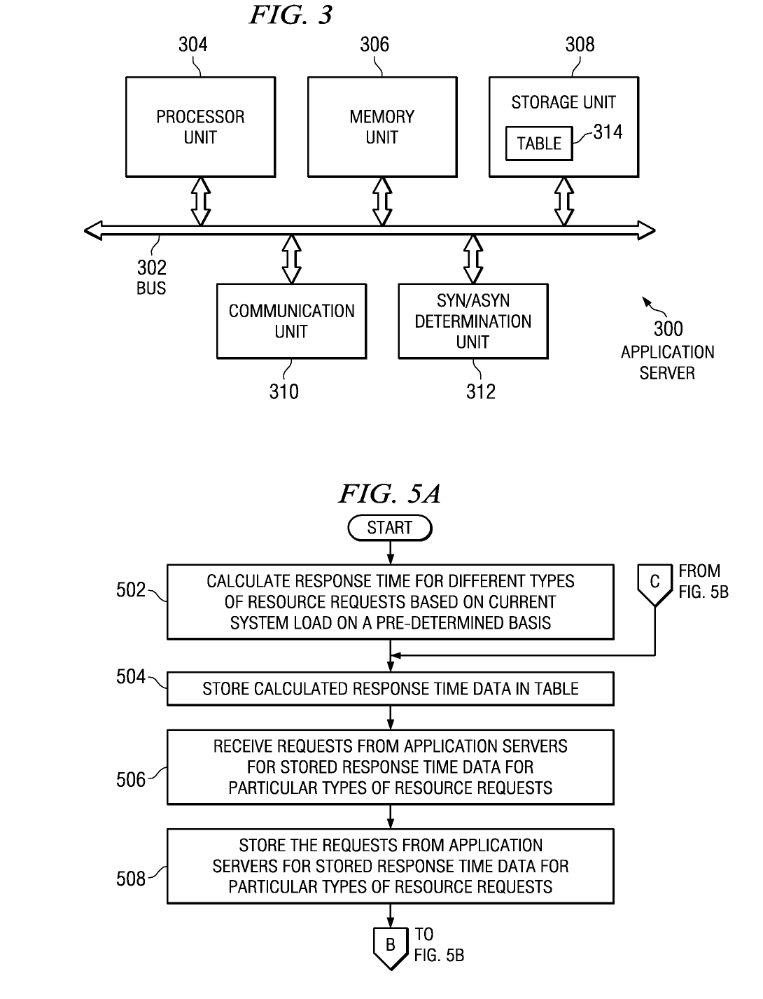

With reference now to FIG. 3, a block diagram of an application server is depicted in accordance with an illustrative embodiment. Application server 300 may, for example, be implemented in application server 104 in FIG. 1 and data processing system 200 in FIG. 2. In this illustrative example of FIG. 3, application server 300 utilizes a bus architecture, such as bus 302. Bus 302 may, for example, be bus 238 in FIG. 2. Bus 302 may include one or more buses. In addition, bus 302 may be implemented using any type of communication fabric or architecture that provides for a transfer of data between the different components and devices coupled to bus 302.

Application server 300 includes processor unit 304, memory unit 306, storage unit 308, communication unit 310, and SYN/ASYN determination unit 312, which connects to bus 302. However, it should be noted that application server 300 is only shown for exemplary purposes and is not meant as an architectural limitation to illustrative embodiments. In other words, application server 300 may include more or fewer components as necessary to accomplish processes of illustrative embodiments for determining whether to send a synchronous resource request or an asynchronous resource request based on response time data provided by a resource server, such as resource server 106 in FIG. 1, for the particular type of resource request.

Processor unit 304 provides the data processing capabilities of application server 300. Processor unit 304 may, for example, be processing unit 206 in FIG. 2. An OS runs on processor unit 304 and coordinates and provides control of various components within application server 300. In addition, software applications executing on application server 300 may run in conjunction with the OS.

Storage unit 308 is a non-volatile data storage device that may, for example, be configured as ROM, such as ROM 224 in FIG. 2, and/or flash ROM to provide the non-volatile memory for storing the OS and/or other data. Storage unit 308 stores instructions or computer usable program code for the OS and applications. The instructions are loaded into memory unit 306 for execution by processor unit 304. Processor unit 304 performs processes of illustrative embodiments by executing the computer usable program code that is loaded into memory unit 306. Memory unit 306 may, for example, be main memory 208 in FIG. 2.

The other data stored in storage unit 308 may, for example, be response time data for particular types of resource requests. The response time data is information regarding the amount of time the resource server requires to provide a response to the particular types of resource requests. Application server 300 may, for example, store the response time data in a table, such as table 314, within storage unit 308. In addition, the other data may, for example, include context-switch times provided by the OS and/or SYN/ASYN determination unit 312. However, it should be noted that storage unit 308 may contain any necessary data for processes of illustrative embodiments to properly execute.

Application server 300 uses communication unit 310 to communicate with other data processing systems, such as the resource server, via a network, such as network 102 in FIG. 1. Communication unit 310 may include one or more devices used to transmit and receive data. For example, communication unit 310 may include a network adapter and/or a modem, such as, for example, network adapter 212 and modem 222 in FIG. 2, to send and receive wire and wireless transmissions.

Application server 300 uses SYN/ASYN determination unit 312 to determine whether to send a synchronous resource request or an asynchronous resource request based on broadcast response time data provided by the resource server. Initially, SYN/ASYN determination unit 312 sends a request to the resource server to receive response time data from the resource server for particular types of resource requests on a regular or irregular periodic basis. After receiving the requested response time data, SYN/ASYN determination unit 312 stores the requested response time data in a table within storage unit 308. Subsequently, when a requester wants to send a particular type of resource request to the resource server, SYN/ASYN determination unit 312 searches the response time data table for the expected response time for that particular resource request type. Based on information found in the response time data table, or alternatively on default response time data, SYN/ASYN determination unit 312 makes a determination as to whether the requester should send a synchronous or asynchronous resource request to maintain or improve performance of the application server.

It should be noted that the user or the system administrator of application server 300 may enable and disable SYN/ASYN determination unit 312 independently of other components of application server 300. Further, it should be noted that SYN/ASYN determination unit 312 may be implemented entirely as software, hardware, or a combination of software and hardware components. Furthermore, even though in the example above SYN/ASYN determination unit 312 makes the determination to send a synchronous or asynchronous resource request, in an alternative illustrative embodiment the requester, such as the OS or application, which issues the resource request from the application server, may make the determination to send a synchronous or asynchronous resource request, itself.

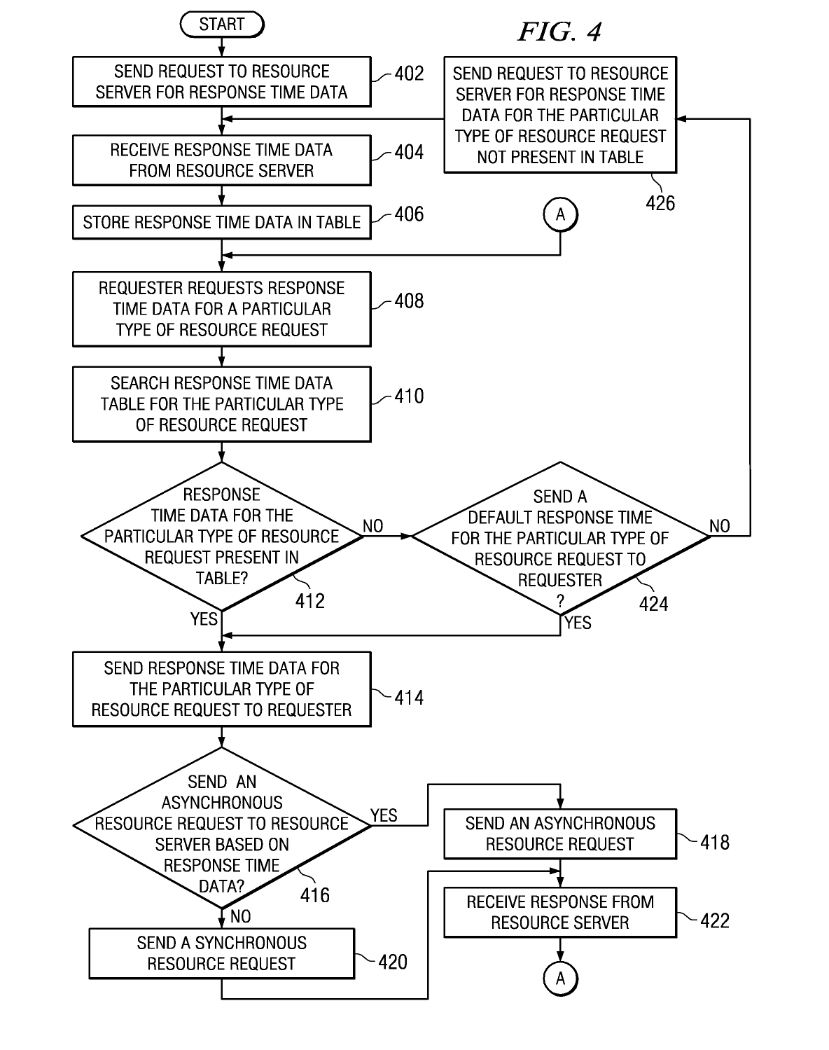

With reference now to FIG. 4, a flowchart illustrating an exemplary process for determining whether to send a synchronous or asynchronous resource request is shown in accordance with an illustrative embodiment. The process shown in FIG. 4 may be implemented in an application server, such as, for example, application server 300 in FIG. 3.

The process begins when the application server uses a SYN/ASYN determination unit, such as, for example, SYN/ASYN determination unit 312 in FIG. 3, to send a request to receive response time data from a resource server, such as, for example, resource server 106 in FIG. 1, for particular types of resource requests (step 402). Subsequent to sending the request to receive response time data for the particular types of resource requests in step 402, the SYN/ASYN determination unit receives the response time data from the resource server (step 404). After receiving the response time data from the resource server in step 404, the SYN/ASYN determination unit stores the requested response time data in a table within a storage device, such as, for example, table 314 within storage unit 308 in FIG. 3 (step 406). It should be noted that the SYN/ASYN determination unit may continue to receive response time data from the resource server on a periodic basis as the process proceeds forward from step 406.

Subsequent to storing the response time data in the table in step 406, the SYN/ASYN determination unit receives a request from a requester for response time data for a particular type of resource request (step 408). After receiving the request from the requester for the response time data for the particular type of resource request in step 408, the SYN/ASYN determination unit searches the response time data table for the particular type of resource request (step 410).

Subsequent to searching the response time data table for the particular type of resource request in step 410, the SYN/ASYN determination unit makes a determination as to whether response time data for the particular type of resource request is present in the table (step 412). If the response time data for the particular type of resource request is present in the table, yes output of step 412, then the SYN/ASYN determination unit sends the response time data for the particular type of resource request to the requester (step 414).

After the SYN/ASYN determination unit sends the response time data for the particular type of resource request to the requester in step 414, the requester makes a determination as to whether to send an asynchronous resource request to the resource server based on the response time data for the particular type of resource request (step 416). However, it should be noted that in an alternative illustrative embodiment, the SYN/ASYN determination unit makes the determination as to whether to send a synchronous or asynchronous resource request.

If the requester does make a determination to send an asynchronous resource request, yes output of step 416, then the requester sends an asynchronous resource request (step 418). If the requester does not make a determination to send an asynchronous resource request, no output of step 416, then the requester sends a synchronous resource request (step 420). Subsequent to either sending an asynchronous resource request in step 418 or a synchronous resource request in step 420, the requester receives a response to the particular resource request from the resource server (step 422). Subsequent to, or concurrent with, receiving the response for the particular resource request in step 422, the process returns to step 408 where a requester requests response time data for a particular type of resource request.

Returning now to step 412, if the response time data for the particular type of resource request is not present in the table, no output of step 412, then the SYN/ASYN determination unit makes a determination as to whether to send a default response time for the particular type of resource request to the requester (step 424). If the SYN/ASYN determination unit does determine to send the default response time for the particular type of resource request, yes output of step 424, then the process returns to step 414 where the SYN/ASYN determination unit sends the default response time data to the requester. If the SYN/ASYN determination unit does not determine to send the default response time for the particular type of resource request, no output of step 424, then the SYN/ASYN determination unit sends a request to the resource server to receive response time data for that particular type of resource request not present in the response time data table (step 426). However, in an alternative illustrative embodiment the SYN/ASYN determination unit always sends a request to the resource server to receive response time data for that particular type of resource request not present in the response time data table no matter whether the SYN/ASYN determination unit sends the default response time data to the requester or not. After sending the request to the resource server to receive response time data for the particular type of resource request not present in the response time data table in step 426, the process returns to step 404 where the SYN/ASYN determination unit receives the response time data from the resource server.

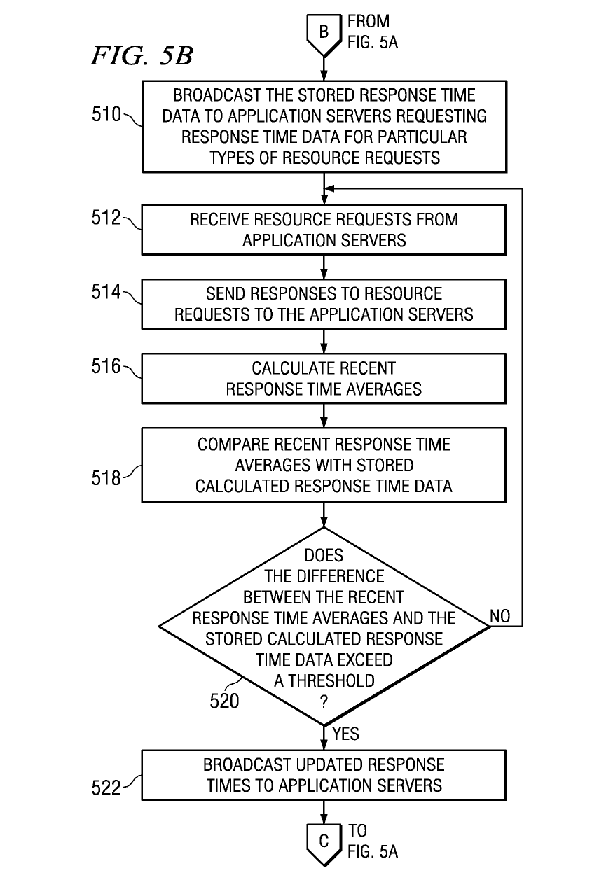

With reference now to FIGS. 5A and 5B, a flowchart illustrating an exemplary process for sending resource request response time data is shown in accordance with an illustrative embodiment. The process shown in FIGS. 5A and 5B may be implemented in a resource server, such as, for example, resource server 106 in FIG. 1.

The process begins when the resource server calculates response times for different types of resource requests based on current system load (step 502). The resource server may, for example, calculate the response times on a pre-determined basis. The pre-determined basis may, for example, be once every minute, five minutes, 10 minutes, hour, or day. However, it should be noted that the user or system administrator may set the pre-determined time interval for calculating response times at any value to optimize system performance. The current system load may be determined, for example, by the lengths of the different resource request queues and the average service time of resource requests in the queues.

Subsequent to calculating the response times for the different types of resource requests based on current system load in step 502, the resource server stores the calculated response time data in a table, such as table 314 in FIG. 3, within a storage unit, such as storage 108 in FIG. 1 (step 504). After storing the calculated response time data in the table in step 504, the resource server receives resource requests from one or more application servers, such as, for example, application server 104 in FIG. 1, for the stored response time data for particular types of resource requests (step 506). Subsequently, the resource server stores the requests from the application server(s) for the response time data for the particular types of resource requests in the storage unit for future reference so that the resource server knows which response time data to send to the application server(s) (step 508).

After storing the application server(s) requests for response time data in step 508, the resource server broadcasts the stored response time data to the application server(s) requesting the response time data for the particular types of resource requests on a regular or irregular periodic basis (step 510). It should be noted that the resource server may continue to calculate and broadcast response time data, along with receive requests from the application server(s) for the response time data, as the process proceeds forward from step 510. Subsequent to broadcasting the stored response time data to the application server(s) in step 510, the resource server receives resource requests from the application server(s) (step 512). Subsequently, the resource server sends responses to the resource requests to the application server(s) (step 514).

After sending the responses to the resource requests in step 514, the resource server calculates recent response time averages (step 516). Afterward, the resource server compares the recent response time averages with the stored calculated response time data (step 518). Subsequent to comparing the recent response time averages with the stored calculated response time data in step 518, the resource server makes a determination as to whether the difference between the recent response time averages and the stored calculated response time data exceeds a threshold (step 520).

If the difference between the recent response time averages and the stored calculated response time data does not exceed the threshold, no output of step 520, then the process returns to step 512 where the resource server continues to receive resource requests from the application server(s). If the difference between the recent response time averages and the stored calculated response time data does exceed the threshold, yes output of step 520, then the resource server broadcasts updated resource request response times to the application server(s) (step 522). After broadcasting the updated resource request response times in step 522, the process returns to step 504 where the resource server stores updated response time data in the table.

Thus, illustrative embodiments provide a computer implemented method, system, and computer usable program code for determining whether to send a synchronous resource request or an asynchronous resource request from the application server based on response time data provided by the resource server for the particular type of resource request in order to increase application server performance. The illustrative embodiments can take the form of an entirely hardware embodiment, an entirely software embodiment or an embodiment containing both hardware and software elements. The illustrative embodiments are implemented in software, which includes but is not limited to firmware, resident software, microcode, etc.

Furthermore, the illustrative embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, RAM, a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the illustrative embodiments have been presented for purposes of illustration and description, and is not intended to be exhaustive or limited to the illustrative embodiments in the form disclosed. Many modifications and variations will be apparent to those of ordinary skill in the art. The embodiment was chosen and described in order to best explain the principles of the illustrative embodiments, the practical application, and to enable others of ordinary skill in the art to understand the illustrative embodiments for various embodiments with various modifications as are suited to the particular use contemplated.

What is claimed is:

1. A computer implemented method for making a determination to send a synchronous or asynchronous resource request, the computer implemented method comprising:
responsive to sending a request to receive response time data for resource requests, receiving the response time data for the resource requests;
storing the response time data for the resource requests;
receiving a request from a requester for response time data for a particular type of resource request;
searching the response time data for the resource requests for the particular type of resource request; and
responsive to determining that the response time data for the particular type of resource request is present within the response time data for the resource requests, sending the response time data for the particular type of resource request to the requester, wherein the requester sends one of a synchronous resource request or an asynchronous resource request based on the response time data for the particular type of resource request.

2. The computer implemented method of claim 1, further comprising:
responsive to determining that the response time data for the particular type of resource request is not present within the response time data for the resource requests, utilizing a default response time for the particular type of resource request.

3. The computer implemented method of claim 1, wherein a resource server calculates the response time data for the resource requests, and wherein the resource server sends the response time data for the resource requests to an application server.

4. The computer implemented method of claim 3, wherein the resource server sends the response time data for the resource requests on a pre-determined periodic time basis.

5. The computer implemented method of claim 3, wherein the resource server sends the response time data for the resource requests if a difference between recent response time averages and calculated response time data exceeds a threshold.

6. The computer implemented method of claim 3, wherein the requester receives a response to the synchronous resource request or the asynchronous resource request from the resource server.

7. The computer implemented method of claim 3, wherein the response time data for the resource requests is stored in a table, and wherein the table resides in a storage unit, and wherein the storage unit resides in the application server.

8. The computer implemented method of claim 1, wherein the requester is one of an operating system, an application, or a thread of a multi-threaded application.

9. The computer implemented method of claim 6, wherein the synchronous resource request is a spin-wait resource request, and wherein the asynchronous resource request is a context-switch resource request.

10. The computer implemented method of claim 9, wherein the spin-wait resource request holds processor cycles until the response is received, and wherein the context-switch resource request cedes processor cycles immediately after sending the context-switch resource request until the response is received.

11. A data processing system for making a determination to send a synchronous or asynchronous resource request, comprising:
a bus system;
a storage device connected to the bus system, wherein the storage device includes a set of instructions; and
a processing unit connected to the bus system, wherein the processing unit executes the set of instructions to receive response time data for resource requests in response to sending a request to receive the response time data for the resource requests, store the response time data for the resource requests, receive a request from a requester for response time data for a particular type of resource request, search the response time data for the resource requests for the particular type of resource request, and send the response time data for the particular type of resource request to the requester in response to determining that the response time data for the particular type of resource request is present within the response time data for the resource requests, wherein the requester sends one of a synchronous resource request or an asynchronous resource request based on the response time data for the particular type of resource request.

12. The data processing system of claim 11, wherein the processing unit executes a further set of instructions to utilize a default response time for the particular type of resource request in response to determining that the response time data for the particular type of resource request is not present within the response time data for the resource requests.

13. The data processing system of claim 11, wherein the data processing system includes a synchronous/asynchronous determination unit, and wherein the synchronous/asynchronous determination unit determines whether to send the synchronous resource request or the asynchronous resource request based on the response time data for the particular type of resource request.

14. A computer program product for making a determination to send a synchronous or asynchronous resource request, the computer program product comprising:
a computer usable medium having computer usable program code embodied therein, the computer usable medium comprising:
computer usable program code configured to receive response time data for resource requests in response to sending a request to receive the response time data for the resource requests;
computer usable program code configured to store the response time data for the resource requests;
computer usable program code configured to receive a request from a requester for response time data for a particular type of resource request;
computer usable program code configured to search the response time data for the resource requests for the particular type of resource request; and
computer usable program code configured to send the response time data for the particular type of resource request to the requester in response to determining that the response time data for the particular type of resource request is present within the response time data for the resource requests, wherein the requester sends one of a synchronous resource request or an asynchronous resource request based on the response time data for the particular type of resource request.

15. The computer program product of claim 14, further comprising:
computer usable program code configured to utilize a default response time for the particular type of resource request in response to determining that the response time data for the particular type of resource request is not present within the response time data for the resource requests.

16. The computer program product of claim 14, wherein a resource server calculates the response time data for the resource requests, and wherein the resource server sends the response time data for the resource requests to an application server.

17. The computer program product of claim 16, wherein the resource server sends the response time data for the resource requests on a pre-determined periodic time basis.

18. The computer program product of claim 16, wherein the resource server sends the response time data for the resource requests if a difference between recent response time averages and calculated response time data exceeds a threshold.

19. The computer program product of claim 14, wherein the requester is one of an operating system, an application, or a thread of a multi-threaded application.

20. The computer program product of claim 14, wherein the synchronous resource request is a spin-wait resource request, and wherein the asynchronous resource request is a context-switch resource request.
